(19) United States
(12) Patent Application Publication
(10) Pub. No.: US 2025/0351887 A1
(43) Pub. Date: Nov. 20, 2025

(54) Press energy-storage type electronic atomizer

(71) Applicant: Dongguan Deke Electronic Technology Co., Ltd., Dongguan (CN)

(72) Inventor: Jinghua Zhang, Dongguan (CN)

(21) Appl. No.: 18/806,961

(22) Filed: Aug. 16, 2024

(30) Foreign Application Priority Data
May 20, 2024 (CN) 2024211025463

(51) Int. Cl. A24F 40/95; A24F 40/42; H02J 7/32

(52) U.S. Cl. CPC A24F 40/95; A24F 40/42; H02J 7/32

(57) ABSTRACT

A press energy-storage type electronic atomizer, which relates to the technical field of electronic atomizers, includes a control assembly electrically connected to a cartridge assembly; an energy storage assembly for supplying energy to the cartridge assembly for operation; and a press power-generating assembly electrically connected to the control assembly; the mechanical energy of the press power-generating assembly is converted into electrical energy stored in the energy storage assembly; according to the press energy-storage type electronic atomizer of the present disclosure, the oil inside the cartridge assembly can be effectively prevented from clouding or leaking, and the press method helps to reduce the length of the housing and improve the grip of the electronic atomizer.

### CROSS REFERENCE TO RELATED APPLICATION

This application claims priority to Chinese patent application No. 202421102546.3, filed with the China National Intellectual Property Administration on May 20, 2024 and entitled “press energy-storage type electronic atomizer”, which is incorporated herein by reference in its entirety.

### TECHNICAL FIELD

The present disclosure relates to the technical field of electronic atomizers, and in particular relates to a press energy-storage type electronic atomizer.

### BACKGROUND

The electronic atomizer is an electronic product that replaces traditional cigarettes, it can simulate the taste of cigarettes by atomizing the oil, helping consumers to reduce their dependence on traditional cigarettes to reduce the frequency of smoking. Compared with traditional cigarettes, the atomization produces fewer harmful substances, such that it is more friendly to the environment and people around. The structure of the electronic atomizer consists mainly of an atomizer and an oil. The atomizer is electrified to generate heat to heat and atomize the internal oil, and the atomized oil mist is available for the user to inhale. The amount of oil mist generated depends on the efficiency of the oil transferred to the atomizer and the power with which the atomizer operates.

CN201621423234.8 discloses a self-generating box used for an e-cigarette, including a box body and a dividing plate. The dividing plate is L-shaped, the charging head is located on the short side plate of the dividing plate. The dividing plate divides the box body into a power generating cavity and a charging cavity. A number of coils are fixedly connected in the charging cavity, and magnet strips are placed inside the coils. The upper and lower end surfaces of the charging cavity are fixedly connected with a stabilizing slide groove and a supporting slide groove, respectively, corresponding to the center of the coils, and the magnet strips are placed inside the coils. The upper and lower ends of the magnet strips are slidingly connected to the stabilizing and supporting slide grooves, and the power generating cavity is also fixedly connected to a collector plate equipped with two electrode heads electrically connected to the ends of each coil, and the two electrode heads are electrically connected to the charging terminals of the storage battery.

Existing electronic atomizers with a self-generating function use hand-cranking to store energy. The internal oil of the electronic atomizer shakes frequently during the energy storage process, such that it can easily lead to oil leakage and affect the quality of inhalation. Moreover, the low efficiency of the hand-cranked energy storage makes the electronic atomizer length increase, and grip feeling poor.

### SUMMARY

The present disclosure is at least intended to solve the technical problem of “electronic atomizer energy storage by hand shaking method easily leading to oil leakage, affecting the quality of inhalation and low hand shaking energy storage efficiency, poor grip feeling” that exists in the existing technology. In this regard, the present disclosure provides a press energy storage type electronic atomizer, the use of press energy storage, through the transmission structure to improve the efficiency of energy storage, and effectively prevent the leakage of oil due to shaking. The layout of the power generating structure is optimized to improve the gripping feel of the housing.

The press energy-storage type electronic atomizer according to some embodiments of the present disclosure, comprising a housing provided with a grip part and an insertion part detachably connected with a cartridge assembly; the electronic atomizer comprises:
a control assembly provided inside the grip part and electrically connected to the cartridge assembly;
an energy storage assembly electrically connected to the control assembly and configured for supplying power to the cartridge assembly for operation; and
a press power generating assembly provided inside the grip part and electrically connected to the control assembly;
wherein the press power generating assembly comprises a power generating grip hingedly connected to the grip part, a power generating turntable connected in transmission to the power generating grip, and a power generating mechanism connected in transmission to the power generating turntable, the power generating mechanism is electrically connected to the control assembly; and mechanical energy of the press power generating assembly are converted into electrical energy stored in the energy storage assembly.

According to some embodiments of the present disclosure, the grip part is provided with a press groove; one end of the power generating grip is hingedly connected to the grip part, and another end protrudes from an end surface of the press groove;

a hinged joint of the power generating grip and the grip part is provided with a reset elastic member; when the power generating grip is pressed towards the press groove by an external force, a resilient potential energy of the reset elastic member increases; and when the external force applied to the power generating grip disappears, the resilient potential energy of the reset elastic member is converted into kinetic energy to drive a resetting of the power generating grip.

According to some embodiments of the present disclosure, the power generating turntable is rotationally connected inside the grip part, and comprises a drive gear and a variable-speed gear that are coaxially provided; the drive gear and the variable-speed gear rotate synchronously, and the power generating grip is engaged in transmission with the drive gear.

According to some embodiments of the present disclosure, the power generating grip is provided with a power generating rack engaged with the drive gear; and the power generating rack drives the power generating turntable to rotate when the power generating grip is pressed.

According to some embodiments of the present disclosure, the power generating mechanism is provided with a driven gear engaged in transmission with the variable-speed gear.

According to some embodiments of the present disclosure, the variable-speed gear and the driven gear have a gear ratio of 5 to 7.

According to some embodiments of the present disclosure, a peripheral edge of the grip part corresponding to the press groove is in a form of a concave arc.

According to some embodiments of the present disclosure, the control assembly is provided with a manipulation button, and the manipulation button protrudes from an end surface of the housing.

According to some embodiments of the present disclosure, the insertion part is provided with an insertion groove, the control assembly is provided with a contact thimble, the contact thimble extends to a bottom of the insertion groove, and the cartridge assembly is detachably connected inside the insertion groove and abuts against the contact thimble.

According to some embodiments of the present disclosure, the insertion part is provided with level view windows that are hollow, the level view windows are aligned with an oil storage area of the cartridge assembly.

According to some embodiments of the present disclosure, the press energy storage type electronic atomizer has at least the following beneficial effects:

The press power generating assembly can generate and store energy without shaking the housing, and only needs to drive the power generating mechanism through the power generating grip and the power generating turntable, the generated electricity is stored in the energy storage assembly, and the energy storage efficiency is higher. Turbidity or leakage of oil inside the cartridge assembly can be effectively prevented, and the pressing method is conducive to reducing the length of the housing and improving the gripping feel of the electronic atomizer.

Additional aspects and advantages of the present disclosure will be partially explained in the following description, and partially will become apparent from the following description, or learned through the practice of the present disclosure.

### BRIEF DESCRIPTION OF DRAWINGS

The foregoing and/or additional aspects and advantages of the present disclosure will become apparent and readily understood from the description of embodiments in combination with the following figures, wherein:

FIG. 1 shows a three-dimensional schematic diagram of a press energy-storage type electronic atomizer according to an embodiment of the present disclosure;

FIG. 2 shows a first partial schematic diagram of a press energy-storage type electronic atomizer according to an embodiment of the present disclosure;

FIG. 3 shows a second partial schematic diagram of a press energy-storage type electronic atomizer according to an embodiment of the present disclosure;

FIG. 4 shows an explosive schematic diagram of a press energy-storage type electronic atomizer according to an embodiment of the present disclosure.

### REFERENCE SIGNS

casing 100, insertion part 110, insertion groove 111, level view window 112, grip part 120, press groove 121, cartridge assembly 130,
control assembly 200, manipulation button 210, contact thimble 220, energy storage assembly 300,
press power generating assembly 400, power generating grip 410, power generating rack 412, power generating turntable 420, drive gear 421, variable-speed gear 422, power generating mechanism 430, and driven gear 431.

### DESCRIPTION OF EMBODIMENTS

Embodiments of the present disclosure are described in detail below, and examples of the embodiments are shown in the figures. Among them, the same or similar reference signs from the beginning to the end denote the same or similar elements or elements having the same or similar functions. The embodiments described below by reference to the figures are exemplary and are used only for explaining the present disclosure and are not to be construed as a limitation of the present disclosure.

In the description of the present disclosure, it is to be understood that the orientation or positional relationships indicated involving orientation descriptions such as top, bottom, front, rear, left, right, top, bottom, etc. are based on the orientation or positional relationships shown in the figures, they are only for the purpose of facilitating the description of the present disclosure and simplifying the description, and are not indicative of, or suggestive of, the fact that the referred device or elements must have a particular orientation, be constructed and operated with a particular orientation, and therefore cannot be construed as a limitation of the present disclosure.

In the description of the present disclosure, a number means one or more, a plurality means more than two, greater than, less than, more than, etc. are understood to exclude the present number, and above, below, within, etc. are understood to include the present number. If a description is presented to the first and the second, it is only used for the purpose of distinguishing the technical features, and is not to be understood as indicating or implying the relative importance or implicitly specifying the number of the indicated technical features or implicitly specifying the sequential relationship of the indicated technical features.

In the description of the present disclosure, unless otherwise expressly limited, the terms providing, installation, connection and the like shall be broadly construed, and the technicians in the technical field may reasonably determine the specific meanings of the terms in the present disclosure in conjunction with the specific contents of the technical solution.

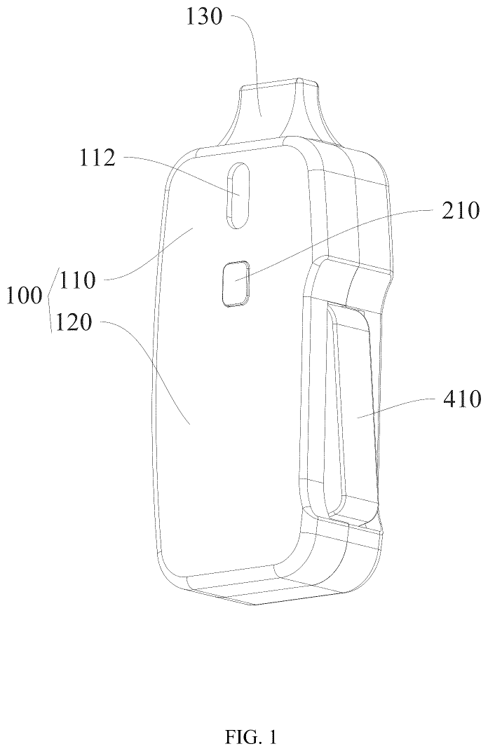

With reference to FIGS. 1-FIG. 4, a press energy-storage type electronic atomizer according to an embodiment of the present disclosure is described below.

As shown in FIG. 1-FIG. 4, the press energy-storage type electronic atomizer includes a housing 100 and a cartridge assembly 130, the cartridge assembly 130 can be used as a disposable or reusable assembly. The housing 100 is provided with a grip part 120 and an insertion part 110 that are integrally formed, and the cartridge assembly 130 is detachably connected to the insertion part 110. A user's hand is held in the region of the grip part 120 of the housing 100 when using the press energy-storage type electronic atomizer according to the present embodiment.

Specifically, the press energy-storage type electronic atomizer further comprises a control assembly 200, an energy storage assembly 300, and a press power generating assembly 400, and both the control assembly 200 and the press power generating assembly 400 are provided inside the grip part 120. In the embodiment, the energy storage assembly 300 is also provided inside the grip part 120.

The control assembly 200 is a PCB control circuit electrically connected to the cartridge assembly 130, capable of controlling the heating wire inside the cartridge assembly 130 to heat the oil to form an oil mist to be ejected from the nozzle of the cartridge assembly 130. The energy storage assembly 300 is electrically connected to the control assembly 200 for powering the cartridge assembly 130.

The cartridge assembly 130 includes an oil storage compartment, an atomizing-heating core connected to the oil storage compartment, and a channel nozzle for delivering the atomized oil. The internal structure of the cartridge assembly 130 is a technical solution known to those skilled in the art and will not be described in detail in the embodiment. The atomizing-heating core obtains electrical energy from the energy storage assembly 300 via the control assembly 200, to heat the heating wire to atomize the smoke oil. The energy storage assembly 300 uses a rechargeable battery for energy storage.

Among other things, the press power generating assembly 400 includes a power generating grip 410 hingedly connected to the grip part 120, a power generating turntable 420 connected in transmission to the power generating grip 410, and a power generating mechanism 430 connected in transmission to the power generating turntable 420. The power generating mechanism 430 is electrically connected to the control assembly 200, and the mechanical energy of the press power generating assembly 400 is converted into electrical energy to be stored in the energy storage assembly 300.

Specifically, the press power generating assembly 400 in the embodiment drives the power generating turntable 420 by reciprocal pressing of the grip part 120, the power generating turntable 420 and the power generating mechanism 430 form a core power generating assembly, and the power generating mechanism 430 is driven by the power generating turntable 420 to continually generate induced electric potential. The control assembly 200 rectifies and regulates the current and inputs it into the energy storage assembly 300 for energy storage. When the cartridge assembly 130 is in operation, the control assembly 200 controls the discharge of the energy storage assembly 300.

The basic principle of power generating in the power generating mechanism 430 is that the rotor rotates in a magnetic field, and the coil will cut the magnetic inductance under the action of magnetic force, thus generating an induced electromotive force in the coil. The internal coils form a closed loop in which a current is formed.

Compared with the existing power generating method in which a magnet strip slides through the coil to generate electric current, the press energy-storage type electronic atomizer according to the present disclosure has a housing 100 shorter in length, making it easier for the user to hold and use. And there is no need to shake the housing 100 up and down during the power generating process, which effectively prevents the oil inside the cartridge assembly 130 from being cloudy, seeping into gas or leaking. The effect of smoking oil absorption of the self-powered electronic atomizer is improved.

The power generating grip 410 drives the power generating mechanism 430 by means of the power generating turntable 420 to realize the efficient work of the power generating mechanism 430 by adjusting the transmission ratio. In the condition of equal user consumption, according to the present embodiment, the press energy-storage electronic atomizer can store energy more efficiently.

In some embodiments of the present disclosure, as shown in FIG. 1-FIG. 3, the grip part 120 is provided with a press groove 121, and one end of the power generating grip 410 is hingedly connected to the grip part 120, and the other end protrudes from the end surface of the press groove 121.

Specifically, the power generating grip 410 partially protrudes above the press groove 121 in an initial state, and a user causes the power generating grip 410 to be pressed downwardly toward the interior of the press groove 121 by pressing the power generating grip 410.

A reset elastic member (not shown in the figures) is provided at the hinged joint of the power generating grip 410 and the grip part 120. When the power generating grip 410 is pressed toward the inside of the press groove 121 by an external force, an elastic potential energy of the reset elastic member increases. When the external force applied to the power generating grip 410 disappears, the elastic potential energy of the reset elastic member is converted into kinetic energy that drives the power generating grip 410 to reset.

Specifically, the reset elastic member may adopt a metal torsion spring, the metal torsion spring is socketed to the articulated rotor shaft of the power generating grip 410. The kinetic energy consumed by the user pressing the power generating grip 410 down is partially converted into the potential energy of the metal torsion spring, and partially converted into the kinetic energy of the power generating turntable 420 for rotation. Adjusting the transmission ratio of the power generating turntable 420 can change the working efficiency of the power generating mechanism 430 and thus improve the energy storage efficiency of the press energy-storage type electronic atomizer.

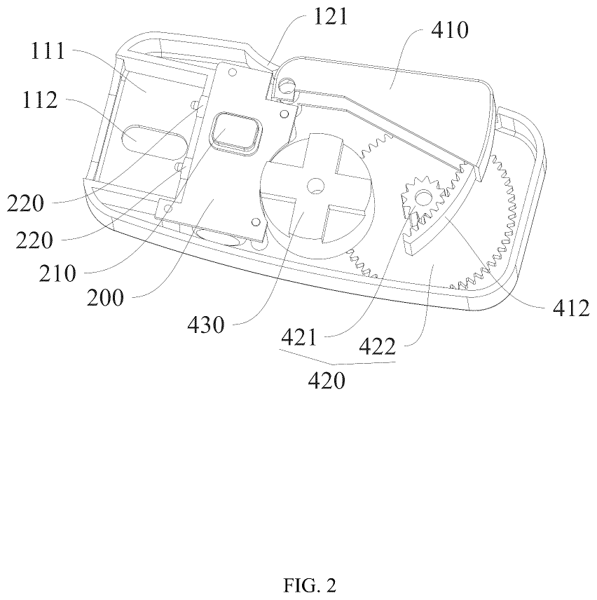

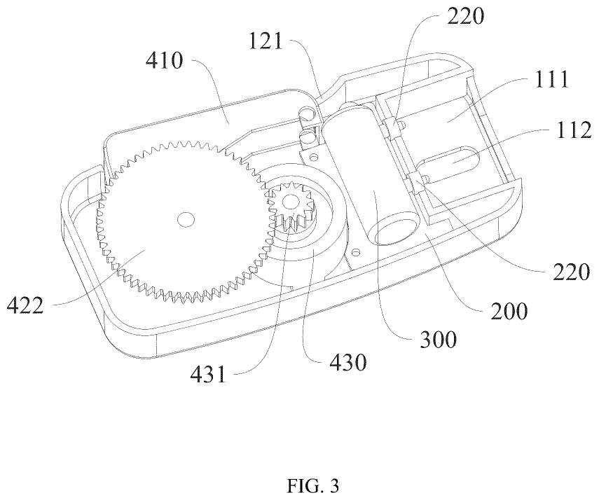

In some embodiments of the present disclosure, as shown in FIGS. 2 and 3, the power generating turntable 420 is rotationally connected to the grip part 120, including a drive gear 421 and a variable-speed gear 422 that is coaxially provided, the drive gear 421 and the variable-speed gear 422 rotate in synchronization, and the power generating grip 410 is engaged in transmission with the drive gear 421.

Specifically, in the embodiment, the power generating turntable 420 adopts a two-stage transmission structure, and the variable-speed gear 422 wheel adopts a deceleration structure, so as to increase the output torque of the power generating turntable 420, and to improve the working efficiency of the power generating mechanism 430. The adoption of a double-gear structure for the drive gear 421 and the variable-speed gear 422 improves the coaxiality of the two gears and ensures that the angular velocities of the two gears are equal. This is conducive to reducing the volume occupation of the power generating turntable 420 and improving the space utilization rate of the internal assemblies of the housing 100.

In some embodiments of the present disclosure, as shown in FIGS. 2 and 3, the power generating part is provided with a power generating rack 412, the power generating rack 412 is meshed and connected with the driving teeth 421, and when the power generating part 410 is pressed, the power generating rack 412 drives the power generating turntable 420 to rotate.

Specifically, the power generating rack 412 is provided at an end of the power generating part 410 away from the hinged joint, and the power generating rack 412 and the power generating part 410 rotate with the grip hinged joint as the rotation center. The power generating rack 412 drives the drive gear 421 to drive the power generating turntable 420 and the power generating mechanism 430 for operation.

In some embodiments of the present disclosure, as shown in FIGS. 2 and 3, the power generating mechanism 430 is provided with a driven gear 431, and the driven gear 431 is engaged in transmission with the variable-speed gear 422. Specifically, the driven gear 431 are connected to a rotor inside the power generating mechanism 430, and an induced electromotive force is generated by driving the rotor to rotate at a high speed through the driven gear 431. In order to increase the rotor speed, there is an increasing gear ratio between the driven gear 431 and the variable-speed gear 422.

In further embodiments, as shown in FIGS. 2 and 3, the gear ratio between the variable-speed gear 422 and the driven gear 431 is 5 to 7. Specifically, the gear ratio between the variable-speed gear 422 and the driven gear 431 is adaptively adjusted according to the space inside the grip part 120. In order to keep the power generating efficiency of the power generating mechanism 430 in a usable range, the gear ratio between the variable-speed gear 422 and the driven gear 431 adopted in the embodiment is between 5 and 7.

The transmission ratio within the range can achieve a relative balance between the power generating efficiency and the physical exertion of the user. The transmission ratio that is too large causes the user to have difficulty in pressing the power generating grip 410, and the short-time pressing consumes physical strength too quickly, making it difficult to stimulate the user's interest in pressing to exercise the grip. The transmission ratio that is too small results in low power generating efficiency of the power generating mechanism 430, which cannot meet the power demand of the press energy-storage electronic atomizer.

In some embodiments of the present disclosure, as shown in FIG. 1-FIG. 4, the peripheral edge of the grip part 120 corresponding to the press groove 121 is in the form of a concave arc. Specifically, when the power generating grip 410 is pressed to the bottom, the user's thumb fits with the concave arc opening, which does not produce a cutting sensation and provides a better gripping experience.

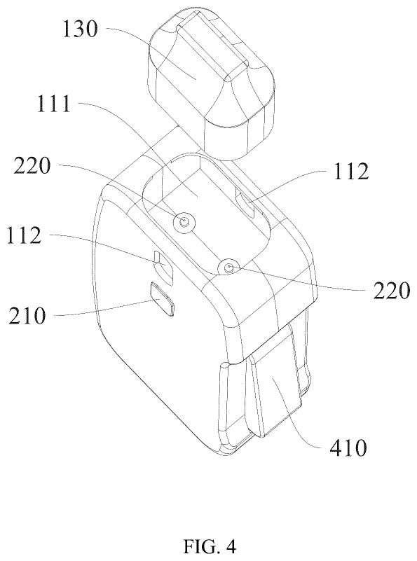

In some embodiments of the present disclosure, as shown in FIGS. 1 and 4, the control assembly 200 is provided with a manipulation button 210, and the manipulation button 210 is provided protruding from the end surface of the housing 100. Specifically, the user is able to change the working state of the control assembly 200 by pressing the manipulation button 210, such that the press energy-storage electronic atomizer heats up the oil.

In some embodiments of the present disclosure, as shown in FIG. 2-FIG. 4, the insertion part 110 is provided with a insertion groove 111, the control assembly 200 is provided with a contact thimble 220, the contact thimble 220 extends to the bottom of the insertion groove 111, and the cartridge assembly 130 is detachably connected to the insertion groove 111 and abuts against the contact thimble 220.

Specifically, the contour of the insertion groove 111 matches the contour of the cartridge assembly 130. When the cartridge assembly 130 is inserted into the insertion groove 111, the contact points at the bottom of the cartridge assembly 130 are pressed against the contact thimbles 220 at the bottom of the insertion groove 111, such that the atomizing core heating wire of the cartridge assembly 130 is inducted with the control assembly 200. At this time, the control assembly 200 can control the cartridge assembly 130 to work.

In some embodiments of the present disclosure, as shown in FIGS. 2 and 4, the insertion part 110 is provided with hollow level view windows 112, and each level view window 112 aligns with the oil storage area of the cartridge assembly 130. The user is able to observe the internal oil condition of the cartridge assembly 130 at any time through the level view windows 112 on both sides of the housing 100. It is convenient for the user to replace consumables or replenish the oil in a timely manner.

In the description of this specification, description of the reference terms “an embodiment”, “some embodiments”, “schematic embodiment”, “example”, “specific example”, or “some examples” and the like means that the specific features, structures, materials, or characteristics described in connection with the embodiment or example are included in at least one embodiment or example of the present disclosure. In the specification, schematic expressions of the above terms do not necessarily refer to the same embodiment or example. Moreover, the specific features, structures, materials, or characteristics described may be combined in any one or more embodiments or examples in a suitable manner.

Although embodiments of the present disclosure have been shown and described, it can be understood by those of ordinary skill in the art that a variety of changes, modifications, substitutions, and variations can be made to these embodiments without departing from the principles and objects of the present disclosure, and that the scope of the present disclosure is limited by the claims and their equivalents.

1. A press energy-storage type electronic atomizer, comprising a housing (100) provided with a grip part (120) and an insertion part (110), the insertion part (110) being detachably connected with a cartridge assembly (130); wherein the press energy-storage type electronic atomizer comprises:
a control assembly (200) provided inside the grip part (120) and electrically connected to the cartridge assembly (130);
an energy storage assembly (300) electrically connected to the control assembly (200) and configured for supply power to the cartridge assembly (130) for operation; and
a press power generating assembly (400) provided inside the grip part (120) and electrically connected to the control assembly (200);
wherein the press power generating assembly (400) comprises a power generating grip (410) hingedly connected to the grip part (120), a power generating turntable (420) connected in transmission to the power generating grip (410), and a power generating mechanism (430) connected in transmission to the power generating turntable (420), the power generating mechanism (430) is electrically connected to the control assembly (200); and mechanical energy of the press power generating assembly (400) are converted into electrical energy stored in the energy storage assembly (300).

2. The press energy-storage type electronic atomizer according to claim 1, wherein the grip part (120) is provided with a press groove (121); one end of the power generating grip (410) is hingedly connected to the grip part (120), and another end protrudes from an end surface of the press groove (121);
a hinged joint of the power generating grip (410) and the grip part (120) is provided with a reset elastic member; when the power generating grip (410) is pressed towards the press groove (121) by an external force, a resilient potential energy of the reset elastic member increases; and when the external force applied to the power generating grip (410) disappears, the resilient potential energy of the reset elastic member is converted into kinetic energy to drive a resetting of the power generating grip (410).

3. The press energy-storage type electronic atomizer according to claim 2, wherein the power generating turntable (420) is rotationally connected inside the grip part (120), and comprises a drive gear (421) and a variable-speed gear (422) that are coaxially provided; the drive gear (421) and the variable-speed gear (422) rotate synchronously, and the power generating grip (410) is engaged in transmission with the drive gear (421).

4. The press energy-storage type electronic atomizer according to claim 3, wherein the power generating grip is provided with a power generating rack (412) engaged with the drive gear (421); and the power generating rack (412) drives the power generating turntable (420) to rotate when the power generating grip (410) is pressed.

5. The press energy-storage type electronic atomizer according to claim 4, wherein the power generating mechanism (430) is provided with a driven gear (431) engaged in transmission with the variable-speed gear (422).

6. The press energy-storage type electronic atomizer according to claim 5, wherein the variable-speed gear (422) and the driven gear (431) have a gear ratio of 5 to 7.

7. The press energy-storage type electronic atomizer according to claim 2, wherein a peripheral edge of the grip part (120) corresponding to the press groove (121) is in a form of a concave arc.

8. The press energy-storage type electronic atomizer according to claim 1, wherein the control assembly (200) is provided with a manipulation button (210), and the manipulation button (210) protrudes from an end surface of the housing (100).

9. The press energy-storage type electronic atomizer according to claim 1, wherein the insertion part (110) is provided with an insertion groove (111), the control assembly (200) is provided with a contact thimble (220), the contact thimble (220) extends to a bottom of the insertion groove (111), and the cartridge assembly (130) is detachably connected inside the insertion groove (111) and abuts against the contact thimble (220).

10. The press energy-storage type electronic atomizer according to claim 9, wherein the insertion part (110) is provided with level view windows (112) that are hollow, the level view windows (112) are aligned with an oil storage area of the cartridge assembly (130).
